(19) United States
(12) Patent Application Publication
(10) Pub. No.: US 2017/0155128 A1
(43) Pub. Date: Jun. 1, 2017

(54) CATHODE COMPOSITE MATERIAL AND LITHIUM ION BATTERY USING THE SAME

(71) Applicants: JIANGSU HUADONG INSTITUTE OF LI-ION BATTERY CO., LTD., Suzhou (CN); TSINGHUA UNIVERSITY, Beijing (CN)

(72) Inventors: Xiang-Ming He, Beijing (CN); Guan-Nan Qian, Suzhou (CN); Yu-Ming Shang, Beijing (CN); Li Wang, Beijing (CN); Ju-Ping Yang, Beijing (CN); Jian-Jun Li, Beijing (CN); Peng Zhao, Beijing (CN); Jian Gao, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/428,383

(22) Filed: Feb. 9, 2017

Related U.S. Application Data
(63) Continuation of application No. PCT/CN2015/081514, filed on Jun. 16, 2015.

(30) Foreign Application Priority Data
Aug. 11, 2014 (CN) 201410391793.4

(51) Int. Cl. H01M 4/36; H01M 4/485; H01M 4/62; H01M 10/0525

(52) U.S. Cl. CPC H01M 4/362; H01M 10/0525; H01M 4/485; H01M 4/62; H01M 2004/028

(57) ABSTRACT

A cathode composite material is disclosed. The cathode composite material comprises a cathode active material and a maleimide type monomer composed with the cathode active material. The cathode active material is a lithium transition metal oxide. The maleimide type monomer comprises at least one of a maleimide monomer, a bismaleimide monomer, a multimaleimide monomer, a maleimide type derivative monomer, and combinations thereof. A lithium ion battery is also disclosed.

### CROSS-REFERENCE TO RELATED APPLICATIONS

This application claims all benefits accruing under 35 U.S.C. §119 from China Patent Application No. 201410391793.4, filed on Aug. 11, 2014 in the State Intellectual Property Office of China, the content of which is hereby incorporated by reference. This application is a continuation under 35 U.S.C. §120 of international patent application PCT/CN2015/081514 filed on Jun. 16, 2015, the content of which is also hereby incorporated by reference.

### FIELD

The present disclosure relates to cathode composite materials and lithium ion batteries using the same.

### BACKGROUND

With the rapid development and generalization of portable electronic products, there is an increasing need for lithium ion batteries due to their excellent performance and characteristics such as high energy density, long cyclic life, no memory effect, and light pollution when compared with conventional rechargeable batteries. However, the explosion of lithium ion batteries for mobile phones and laptops has occurred often in recent years, which has aroused public attention to the safety of the lithium ion batteries. The lithium ion batteries could release a large amount of heat if overcharged/discharged, short-circuited, or experiencing large current for long periods time, which could cause burning or explosion due to runaway heat. Stricter safety standards are required in some applications such as electric vehicles.

### BRIEF DESCRIPTION OF THE DRAWINGS

Implementations are described by way of example only with reference to the attached figures.

FIG. 1 is a graph showing cycling performance of one example of a lithium ion battery.

FIG. 2 is a graph showing voltage-time curve and temperature-time curve of one example of a lithium ion battery being overcharged.

FIG. 3 is a graph showing voltage-time curve and temperature-time curve of one comparative example of a lithium ion battery being overcharged.

### DETAILED DESCRIPTION

A detailed description with the above drawings is made to further illustrate the present disclosure.

In one embodiment, a cathode composite material is provided. The cathode composite material comprises a cathode active material and a maleimide type monomer composited with the cathode active material. The cathode active material can be a lithium transition metal oxide. The maleimide type monomer can be mixed uniformly with the cathode active material, or coated on a surface of the cathode active material. A mass percent of the maleimide type monomer in the cathode composite material can be about 0.01% to about 10%, such as about 1% to about 5%, or about 3%.

The maleimide type monomer can comprise at least one of a maleimide monomer, a bismaleimide monomer, a multimaleimide monomer, and a maleimide type derivative monomer.

The maleimide monomer can be represented by formula I:

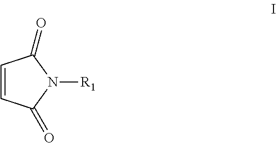

wherein R₁ can be —R, —RNH₂R, —C(O)CH₃, —CH₂OCH₃, —CH₂S(O)CH₃, —C₆H₅, —C₆H₄C₆H₅, —CH₂(C₆H₄)CH₃, alicyclic group, silylated aromatic group, or aromatic halide. R can be an alkyl group with 1 to 6 carbon atoms.

The maleimide monomer can be selected from N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

The bismaleimide monomer can be represented by formula II:

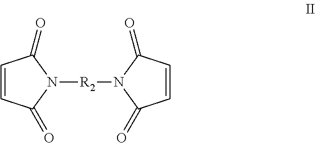

wherein R₂ can be —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)(O)—, phenylene (—C₆H₄—), diphenylene (—C₆H₄C₆H₄—), substituted phenylene, substituted diphenylene, silylated aromatic group, aromatic halide, or —(C₆H₄)—R₅—(C₆H₄)—, wherein R₅ can be —CH₂, —C(O)—, —C(CH₃)₂—, —O—, —O—O—, —S—, —S—S—, —S(O)—, or —(O)S(O)—. R can be an alkyl with 1 to 6 carbon atoms.

The bismaleimide monomer can be selected from N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone, and combinations thereof.

The maleimide type derivative monomer can be obtained by substituting a hydrogen atom of the maleimide monomer, the bismaleimide monomer, or the multimaleimide monomer with a halogen atom.

The cathode active material can be at least one of layer type lithium transition metal oxides, spinel type lithium transition metal oxides, and olivine type lithium transition metal oxides. The cathode active material can be represented by a chemical formula of LiₓNi_{1-y}L_{y}O₂, LiₓCo_{1-y}L_{y}O₂, LiₓMn_{1-y}L_{y}O₂, LiₓFe_{1-y}L_{y}PO₄, LiₓNi_{0.5+z-a}Mn_{1.5-z-b}LₐR_{b}O₄, LiₓNi_{c}Co_{d}MnₑL_{f}O₂, or LiₓMn₂₋ᵢLᵢO₄, wherein 0.1≦x≦1.1, 0≦y<1 (such as 0.1<y<0.5), 0≦z<1.5 (such as 0≦z<0.1), 0≦a−z<0.5, 0≦b+z<1.5, 0<c<1, 0<d<1, 0<e<1, 0≦f≦0.2, c+d+e+f=1, and 0≦i<2. L and R can be selected from at least one of alkali metal elements, alkaline earth metal elements, group 13 elements, group 14 elements, transition metal elements, and rare earth elements, such as at least one of Mn, Cr, Co, Ni, V, Ti, Al, Ga and Mg. The cathode active material can be at least one of olivine type lithium iron phosphate, layer type lithium cobalt oxide, layer type lithium manganese oxide, spinel type lithium manganese oxide, lithium nickel manganese oxide, and lithium cobalt nickel manganese oxide.

The cathode composite material can comprise a conducting agent and/or a binder. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene propylene diene monomer, and styrene-butadiene rubber (SBR).

In one embodiment, components of the cathode composite material can be dispersed in an organic solvent together, stirred, and mixed uniformly to form a slurry. The slurry can be coated on a surface of a cathode current collector, and the organic solvent can be evaporated to form a cathode. In one embodiment, a layer of the maleimide type monomer can be coated on the surface of the cathode active material to form a core-shell structure firstly, followed by mixing the core-shell structure with other components, coating the slurry, and drying to obtain the cathode. In one embodiment, the maleimide type monomer can be melted or dissolved in the organic solvent to form a solution. The cathode active material is then added to the solution, stirred, taken out from the solution, filtered, and dried to form a coating layer of the maleimide type monomer on the surface of the cathode active material.

The uniform mixture of the maleimide type monomer and the cathode active material can be coated on the surface of the cathode current collector as a component of the cathode composite material. The maleimide type monomer can be located inside and at an outer surface of the cathode composite material layer. The maleimide type monomer, especially when being coated on the surface of the cathode active material, can protect the cathode active material effectively at overvoltage to avoid the heat runaway and increase the thermal stability.

In one embodiment, a lithium ion battery is provided. The lithium ion battery can comprise the cathode, an anode, a separator, and an electrolyte liquid. The cathode and the anode are spaced from each other by the separator. The cathode can further comprise the cathode current collector and the cathode composite material located on the surface of the cathode current collector. The anode can further comprise an anode current collector and an anode material located on a surface of the anode current collector. The anode material and the cathode composite material are relatively arranged and spaced by the separator.

The anode material can comprise an anode active material, and can further comprise a conducting agent and a binder. The anode active material can be at least one of lithium titanate, graphite, mesophase carbon micro beads (MCMB), acetylene black, mesocarbon miocrobead, carbon fibers, carbon nanotubes, and cracked carbon. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene propylene diene monomer, and styrene-butadiene rubber (SBR).

The separator can be polyolefin microporous membrane, modified polypropylene fabric, polyethylene fabric, glass fiber fabric, superfine glass fiber paper, vinylon fabric, or composite membrane of nylon fabric and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as ethylene carbonate, diethyl carbonate, propylene carbonate, dimethyl carbonate, ethyl methyl carbonate, butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

### EXAMPLES

### Example 1

Half Cell

80% of LiNi_{1/3}Co_{1/3}Mn_{1/3}O₂, 3% of N-phenyl-maleimide, 7% of PVDF, and 10% of conducting graphite by mass percent are mixed and dispersed by the NMP to form a slurry. The slurry is coated on an aluminum foil and vacuum dried at 120° C. to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested. The N-phenyl-maleimide is represented by formula III:

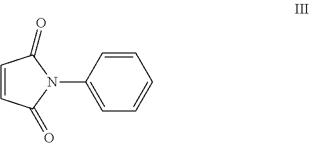 [SMILES: O=C1C=CC(=O)N1c1ccccc1]

Full Cell

94% of graphite anode, 3.5% of PVDF, and 2.5% of conducting graphite by mass percent are mixed and dispersed by the NMP to form a slurry. The slurry is coated on a copper foil, vacuum dried at about 100° C., pressed and cut to obtain an anode. The cathode and the electrolyte liquid are the same as in the half cell in this example. The cathode and the anode are assembled and rolled up to form a 63.5 mm×51.5 mm×4.0 mm sized soft packaged battery.

### Example 2

Half Cell

80% of LiNi_{1/3}Co_{1/3}Mn_{1/3}O₂, 3% of bismaleimide, 7% of PVDF, and 10% of conducting graphite by mass percent are mixed and dispersed by the NMP to form a slurry. The slurry is coated on an aluminum foil and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested. The bismaleimide is represented by formula IV:

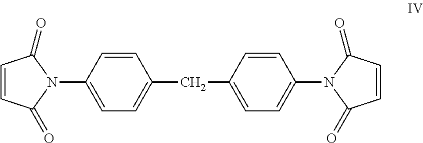 [SMILES: O=C1C=CC(=O)N1c1ccc(Cc2ccc(N3C(=O)C=CC3=O)cc2)cc1]

Full Cell

94% of graphite anode, 3.5% of PVDF, and 2.5% of conducting graphite by mass percent are mixed and dispersed by the NMP to form a slurry. The slurry is coated on a copper foil, vacuum dried at about 100° C., pressed and cut to obtain an anode. The cathode and the electrolyte liquid are the same as in the half cell in this example. The cathode and the anode are assembled and rolled up to form a 63.5 mm×51.5 mm×4.0 mm sized soft packaged battery.

### Example 3

Half Cell

80% of LiNi_{1/3}Co_{1/3}O₂, 3% of bismaleimide, 7% of PVDF, and 10% of conducting graphite by mass percent are mixed and dispersed by the NMP to form a slurry. The slurry is coated on an aluminum foil and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested. The bismaleimide is represented by formula V:

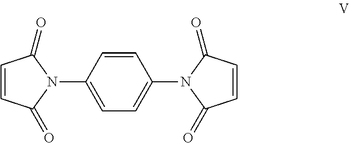 [SMILES: O=C1C=CC(=O)N1c1ccc(N2C(=O)C=CC2=O)cc1]

Full Cell

94% of graphite anode, 3.5% of PVDF, and 2.5% of conducting graphite by mass percent are mixed and dispersed by the NMP to form a slurry. The slurry is coated on an copper foil, vacuum dried at about 100° C., pressed and cut to obtain an anode. The cathode and the electrolyte liquid are the same as in the half cell in this example. The cathode and the anode are assembled and rolled up to form a 63.5 mm×51.5 mm×4.0 mm sized soft packaged battery.

Example 4

Half Cell

80% of LiNi_{1/3}Co_{1/3}Mn_{1/3}O₂, 3% of N,N′-ethenyl-bismaleimide, 7% of PVDF, and 10% of conducting graphite by mass percent are mixed and dispersed by the NMP to form a slurry. The slurry is coated on an aluminum foil and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested.

Full Cell

94% of graphite anode, 3.5% of PVDF, and 2.5% of conducting graphite by mass percent are mixed and dispersed by the NMP to form a slurry. The slurry is coated on a copper foil, vacuum dried at about 100° C., pressed and cut to obtain an anode. The cathode and the electrolyte liquid are the same as in the half cell in this example. The cathode and the anode are assembled and rolled up to form a 63.5 mm×51.5 mm×4.0 mm sized soft packaged battery.

### Comparative Example 1

Half Cell

83% of LiNi_{1/3}Co_{1/3}Mn_{1/3}O₂, 7% of PVDF, and 10% of conducting graphite by mass percent are mixed and dispersed by the NMP to form a slurry. The slurry is coated on an aluminum foil and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested.

Full Cell

94% of LiNi_{1/3}Co_{1/3}Mn_{1/3}O₂, 3% of PVDF, and 3% of conducting graphite by mass percent are mixed and dispersed by the NMP to form a slurry. The slurry is coated on an aluminum foil, vacuum dried at 120° C., pressed and cut to obtain to obtain a cathode.

94% of graphite anode, 3.5% of PVDF, and 2.5% of conducting graphite by mass percent are mixed and dispersed by the NMP to form a slurry. The slurry is coated on a copper foil, vacuum dried at about 100° C., pressed and cut to obtain an anode. 1 M of LiPF₆ is dissolved in a solvent mixture of EC/DEC/EMC=1/1/1(v/v/v) to obtain an electrolyte liquid. The cathode and the anode are assembled and rolled up to form a 63.5 mm×51.5 mm×4.0 mm sized soft packaged battery.

Electrochemical Performance Test

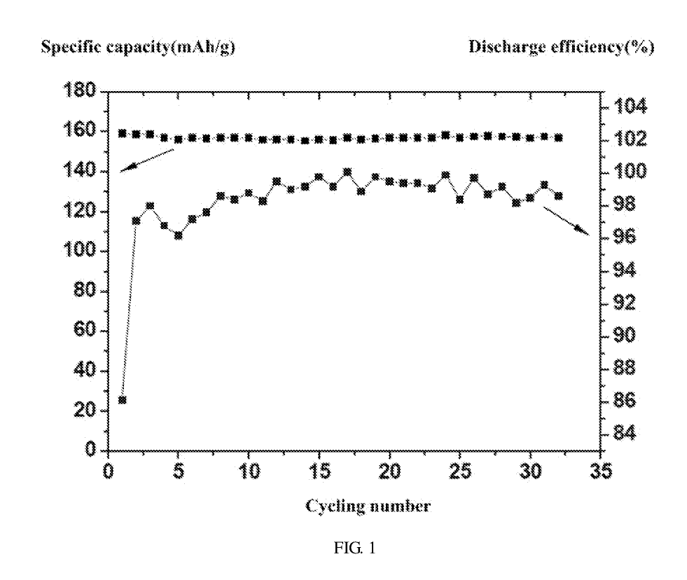

The half cells of Examples 1 to 4 and Comparative Example 1 are charged and discharged at a constant current rate of 0.2 C in the voltage ranged from 2.8V to 4.3V over 30 cycles, and the test results are listed in Table 1. FIG. 1 is a graph showing cycling performance of Example 1 of the half cell. It can be seen from FIG. 1 and Table 1 that there is no significant difference between cycling performances of the half cells in which the maleimide type monomer is added and not added, which shows that the addition of the maleimide type monomer has insignificant effect on the cycling performance to the lithium ion battery being charged and discharged in the normal voltage range.

TABLE 1
Test Data of Cycling Performances of Half Cells of Examples 1 to 4
and Comparative Example 1

| | specific capacity in the | specific capacity in the | capacity retention after |
|---|---|---|---|
| | first cycle (mAh/g) | 30^{th} cycle (mAh/g) | 30 cycles (%) |
| Example 1 | 159.8 | 158.7 | 99.3 |
| Example 2 | 165.4 | 161.2 | 97.5 |
| Example 3 | 157.3 | 151.9 | 96.6 |
| Example 4 | 162.5 | 158.6 | 97.6 |
| Comparative Example 1 | 163.5 | 160.3 | 98 |

Overcharge Test

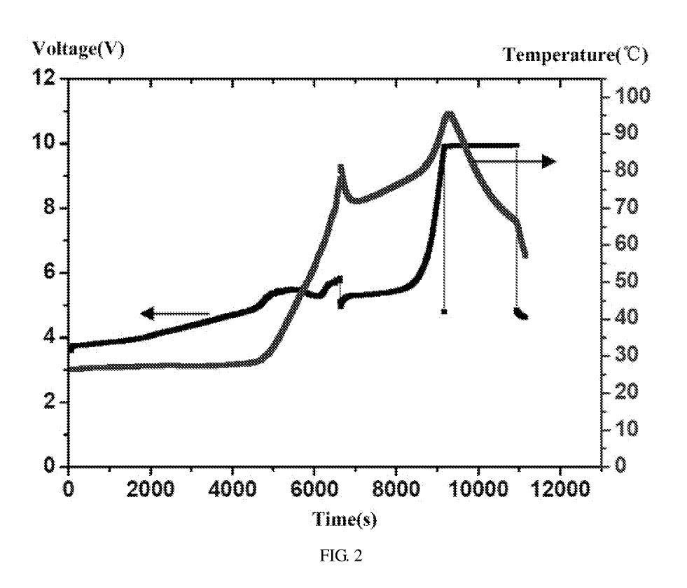

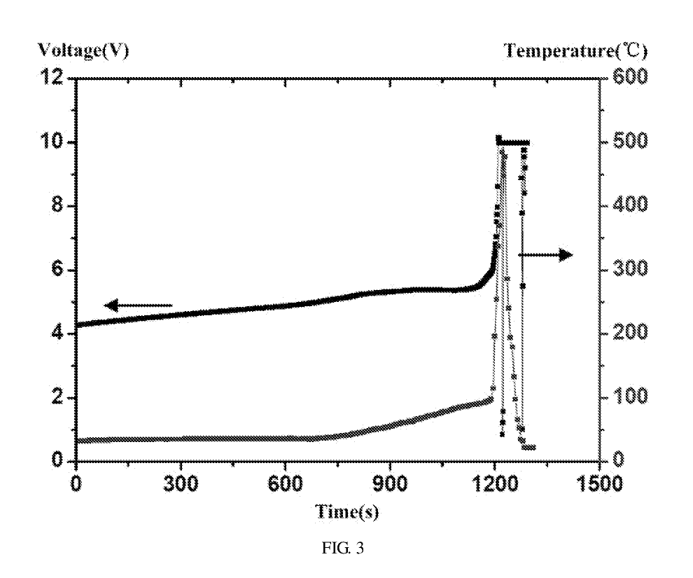

The batteries of Example 1 and Comparative Example 1 are charged at a current rate of 1 C to a cut-off voltage of 10 V. FIG. 2 and FIG. 3 are graphs respectively showing curves of voltages and temperatures with respect to time of the overcharged batteries of Example 1 and Comparative Example 1. It can be seen from FIG. 2 and FIG. 3 that the highest temperature of the battery of Example 1 is about 97° C., and the battery does not show significant deformation in the overcharging process. However, the battery of Comparative Example 1 bursts into flames when it is overcharged to 8V, and the temperature is up to 500° C. The overcharge test data of the other Examples are listed in Table 2. It can be seen from Table 2 that the lithium ion batteries having the cathode in which the maleimide type monomer is added have better overcharging tolerance.

TABLE 2
Overcharge Test Data of Full Cells of Examples 1 to 4 and
Comparative Examples 1

| | Highest | |
|---|---|---|
| | temperature (° C.) | Overcharge phenomenon |
| Example 1 | 97° C. | No significant deformation |
| Example 2 | 94° C. | No significant deformation |
| Example 3 | 98° C. | No significant deformation |
| Example 4 | 95° C. | No significant deformation |
| Comparative Example 1 | 500° C. | Burning |

The maleimide type monomer does not need to be polymerized with other monomers, but can be directly added in the cathode composite material. The addition of the maleimide type monomer improves the electrode stability and thermal stability of the lithium ion battery without affecting the cycling performance thereof, and protects the lithium ion battery during overcharge.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A cathode composite material comprising a cathode active material and a maleimide type monomer composited with the cathode active material, wherein
the cathode active material is a lithium transition metal oxide; and
the maleimide type monomer is selected from the group consisting of maleimide monomer, bismaleimide monomer, multimaleimide monomer, maleimide type derivative monomer, and combinations thereof.

2. The cathode composite material of claim 1, wherein the maleimide type monomer is mixed uniformly with the cathode active material.

3. The cathode composite material of claim 1, wherein the maleimide type monomer is coated on a surface of the cathode active material to form a core-shell structure.

4. The cathode composite material of claim 1, wherein the maleimide monomer is represented by formula I: 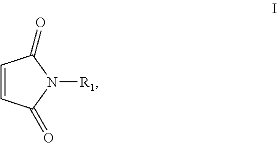
wherein R₁ is selected from the group consisting of —R, —RNH₂R, —C(O)CH₃, —CH₂OCH₃, —CH₂S(O)CH₃, —C₆H₅, —C₆H₄C₆H₅, —CH₂(C₆H₄)CH₃, alicyclic group, silylated aromatic group, and aromatic halide; and R is an alkyl group with 1 to 6 carbon atoms.

5. The cathode composite material of claim 1, wherein the maleimide monomer is selected from the group consisting of N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

6. The cathode composite material of claim 1, wherein the bismaleimide monomer is represented by formula II: 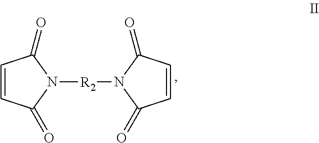
wherein R₂ is selected from the group consisting of —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)(O)—, phenylene, diphenylene, substituted phenylene, substituted diphenylene, silylated aromatic group, aromatic halide, and —(C₆H₄)—R₅—(C₆H₄)—; R₅ is —CH₂—, —C(O)—, —C(CH₃)₂—, —O—, —O—O—, —S—,—S—S—, —S(O)—, and —(O)S(O)—; and R is an alkyl group with 1 to 6 carbon atoms.

7. The cathode composite material of claim 1, wherein the bismaleimide monomer is selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone, and combinations thereof.

8. The cathode composite material of claim 1, wherein a mass percent of the maleimide type monomer in the cathode composite material is in a range from about 0.01% to about 10%.

9. The cathode composite material of claim 1, wherein a mass percent of the maleimide type monomer in the cathode composite material is in a range from about 1% to about 5%.

10. The cathode composite material of claim 1, wherein the cathode active material is represented by a chemical formula selected from the group consisting of LiₓNi_{1-y}L_{y}O₂, LiₓCo_{1-y}L_{y}O₂, LiₓMn_{1-y}L_{y}O₂, LiₓFe_{1-y}L_{y}PO₄, LiₓNi_{0.5+z-a}Mn_{1.5-z-b}LₐR_{b}O₄, LiₓNi_{c}Co_{d}MnₑL_{f}O₂, and LiₓMn₂₋ᵢLᵢO₄; wherein 0.1≦x≦1.1, 0≦y<1, 0≦z<1.5, 0≦a−z<0.5, 0≦b+z<1.5, 0<c<1, 0<d<1, 0<e<1, 0≦f≦0.2,c+d+e+f=1, and 0≦i<2; L and R are selected from the group consisting of alkali metal elements, alkaline earth metal elements, group 13 elements, group 14 elements, transition metal elements, and rare earth elements.

11. The cathode composite material of claim 10, wherein L and R are selected from the group consisting of Mn, Cr, Co, Ni, V, Ti, Al, Ga, and Mg.

12. A lithium ion battery comprising a cathode, an anode, a separator, and an electrolyte liquid, wherein
the cathode comprises a cathode composite material;
the cathode composite material comprises a cathode active material and a maleimide type monomer composited with the cathode active material;
the cathode active material is a lithium transition metal oxide; and
the maleimide type monomer is selected from the group consisting of maleimide monomer, bismaleimide monomer, multimaleimide monomer, maleimide type derivative monomer, and combinations thereof.

13. The lithium ion battery of claim 12, wherein the maleimide type monomer is mixed uniformly with the cathode active material.

14. The lithium ion battery of claim 12, wherein the maleimide type monomer is coated on a surface of the cathode active material to form a core-shell structure.

15. The lithium ion battery of claim 12, wherein the maleimide monomer is represented by formula I: 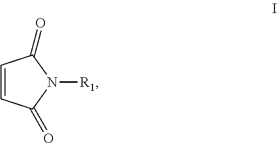
wherein R₁ is selected from the group consisting of —R, —RNH₂R, —C(O)CH₃, —CH₂OCH₃, —CH₂S(O)CH₃, —C₆H₅, —C₆H₄C₆H₅, —CH₂(C₆H₄)CH₃, alicyclic group, silylated aromatic group, and aromatic halide; and R is an alkyl group with 1 to 6 carbon atoms.

16. The lithium ion battery of claim 12, wherein the bismaleimide monomer is represented by formula II: 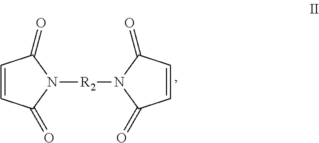
wherein R₂ is selected from the group consisting of —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)(O)—, phenylene, diphenylene, substituted phenylene, substituted diphenylene, silylated aromatic group, aromatic halide, and —C₆H₄)—R₅—(C₆H₄)—; R₅ is —CH₂—, —C(O)—, —C(CH₃)₂—, —O—, —O—O—, —S—, —S—S—, —S(O)—, and —(O)S(O)—; and R is an alkyl group with 1 to 6 carbon atoms.

17. The lithium ion battery of claim 12, wherein a mass percent of the maleimide type monomer in the cathode composite material is in a range from about 0.01% to about 10%.

18. The lithium ion battery of claim 12, wherein a mass percent of the maleimide type monomer in the cathode composite material is in a range from about 1% to about 5%.

19. The lithium ion battery of claim 12, wherein the cathode active material is represented by a chemical formula selected from the group consisting of LiₓNi_{1-y}L_{y}O₂, LiₓCo_{1-y}L_{y}O₂, LiₓMn_{1-y}L_{y}O₂, LiₓFe_{1-y}L_{y}PO₄, LiₓNi_{0.5+z-a}Mn_{1.5-z-b}LₐR_{b}O₄, LiₓNi_{c}Co_{d}MnₑL_{f}O₂, and LiₓMn₂₋ᵢLᵢO₄; wherein 0.1≦x≦1.1, 0≦y<1, 0≦z<1.5, 0≦a−z<0.5, 0≦b+z<1.5, 0<c<1, 0<d<1, 0<e<1, 0≦f≦0.2, c+d+e+f=1, and 0≦i<2;L and R are selected from the group consisting of alkali metal elements, alkaline earth metal elements, group 13 elements, group 14 elements, transition metal elements, and rare earth elements.

20. The lithium ion battery of claim 19, wherein L and R are selected from the group consisting of Mn, Cr, Co, Ni, V, Ti, Al, Ga, and Mg.
